(19) United States
(12) Patent Application Publication
(10) Pub. No.: US 2009/0106893 A1
(43) Pub. Date: Apr. 30, 2009

(54) Inflatable air mattress for rotating patients

(76) Inventor: Jerry Blevins, Toms Brook, VA (US)

Correspondence Address: HOFFMAN, WASSON & GITLER, P.C., 2461 South Clark Street, Suite 522, Arlington, VA, 22202, US

(21) Appl. No.: 12/289,578

(22) Filed: Oct. 30, 2008

Related U.S. Application Data
(60) Provisional application No. 61/000,901, filed on Oct. 30, 2007.

(51) Int. Cl. A47C 27/08; A61G 7/10

(52) U.S. Cl. 5/81.1 RP; 5/715

(57) ABSTRACT

The inflatable air mattress is placed on top of a conventional mattress, and is retained in place by straps that are secured to the bed frame. In the preferred embodiment, the inflatable air mattress includes a pair of identical chambers, the chambers being of rectangular shape and separated by a hinge line. Each chamber is divided into several, parallel cells, and a separate air pump is connected to each chamber. When energized, the pump forces pressurized air into the chamber and rapidly fills same. As the chamber is filled, it expands and is capable of rotating a patient positioned thereon, through a 90° arc of motion. With the intervention of a health care worker, or a nurse, the patient may then be rolled over from his front to his back, or vice versa.

### CROSS-REFERENCE TO RELATED APPLICATIONS

The instant application is predicated upon provisional patent application Ser. No. 61/000,901, filed Oct. 30, 2007, and entitled “Inflatable Patient Transfer Device.”

### FIELD OF THE INVENTION

The instant invention is directed to an inflatable air mattress, that is secured to a bed, and is utilized to rotate a patient from a supine, face up position to a supine, face down position, so that a nursing protocol can be applied to the patient.

### BACKGROUND OF THE INVENTION

Inflatable devices, such as mattresses, pillows, and the like, are available to facilitate the turning of a patient so that a nursing protocol, such as airing bed sores, removing soiled clothing, sponge bathing, etc. can be performed.

To illustrate, U.S. patent application publication 2007/0143928, Biggie et al, published Jun. 28, 2007, discloses a support surface that provides a controllable inflation system for turning a patient quickly for the application of a nursing protocol. The support surface includes air cell array sets 2, 3 (shown in FIG. 1), and turning bladders 37, 38 (shown in FIG. 2), which are used to turn the patient in either direction, under control of the medical practitioner. The multiple turning bladders are formed with a unique butterfly shape 29-32 (shown in FIG. 2) that minimizes the amount of air required to inflate the system.

U.S. Pat. No. 4,934,002, granted Jun. 19, 1990, to Watanabe, discloses a mat assembly that is mounted upon bed frame 1, and which is capable of being tilted about the longitudinal axis thereof by pairs of inflatable air bags 6a, 7a, 6b, 7b. The tiltable mat assembly aids a patient in turning in bed, and prevents the formation of bed sores.

Another variable pressure bed, or mattress, that facilitates turning bed-ridden patients is disclosed in U.S. Pat. No. 1,772,310, granted Aug. 5, 1930, to J. D. Hart.

Other inflatable beds or mattresses that facilitate the turning of patients, to allow the administration of various protocols, and to defeat bed sores, are also known.

However, none of the known, inflatable devices has been capable of completely rotating a patient, from his back to his front, and vice verse, as contrasted with merely turning the patient. Furthermore, none of the known, inflatable devices has been capable of stopping the rotation of the patient, at various steps, or stages, throughout the potential 180° range of motion. Consequently, the need for an inflatable, easy to use, air mattress capable of rotating a patient 180°, with a minimum level of assistance from a nurse or care giver, remains unsatisfied.

### BRIEF SUMMARY OF THE INVENTION

The inflatable air mattress is placed on top of a conventional mattress, and is retained in place by straps that are secured to the bed frame. In the preferred embodiment, the inflatable air mattress includes a pair of identical chambers, the chambers being of rectangular shape and separated by a hinge line. Each chamber is divided into several, parallel cells, and a separate air pump is connected to each chamber. When energized, the pump forces pressurized air into the chamber and rapidly fills same. As the chamber is filled, it expands and is capable of rotating a patient positioned thereon, through a 90° arc of motion. With the intervention of a health care worker, or a nurse, the patient may then be rolled over from his front to his back, or vice versa.

The inflatable air mattress is formed of a rubberized material that retains the pressurized air, with minimal leakage. Each chamber of the air mattress comprises an upper support surface that receives the patient, a lower surface that is secured to the bed frame, and a hinge line, located at the inner edge of the chamber, where the upper and lower surfaces are joined, as by bonding, heat sealing, gluing, or some combination of such techniques. A triangular fold or gusset extends between the upper and lower surfaces at the outer edge of the mattress. The triangular fold or gusset opens to allow the upper surface to rotate about the hinge line, and relative to the fixed lower surface.

The inflatable air mattress is sturdy, easy to operate, and efficient. Patients of various sizes can be rotated easily, with a minimum of assistance, or intervention, by a health care worker. In an alternative embodiment of the inflatable air mattress, the two chambers are separated by a gap, in the vicinity of the hinge line, so that bariatric patients can be rotated.

In other embodiments, the inflatable air mattress relies upon a single chamber to rotate a patient onto a transfer cart positioned adjacent to the bed. A bolster of triangular shape, may be positioned on the hinge line, to facilitate rotating the patient.

Other advantages attributable to the instant, inflatable air mattress will become apparent to the skilled artisan from an inspection of the appended drawings and ensuing specification.

### BRIEF DESCRIPTION OF THE DRAWINGS

FIG. 1 is a perspective view of the preferred embodiment of an inflatable air mattress, employing two chambers, and constructed in accordance with the principles of the invention, the mattress being shown in deflated condition;

FIG. 2 is a perspective view of the inflatable air mattress shown in FIG. 1, but being shown with one chamber in inflated condition;

FIG. 3 is a perspective view of the inflatable air mattress shown in FIG. 2, with a bolster located on the hinge-line of the air mattress;

FIG. 4 is perspective view of the inflatable air mattress secured to a bed, with a patient resting on the mattress;

FIGS. 5-10 show, in sequence, the manner in which the two chambers of the inflatable air mattress of FIG. 1 rotates a patient resting upon a mattress from his back to his front or chest, and then return him to the initial position;

FIG. 11 is a front elevational view of applicant's inflatable air mattress, with both chambers partially inflated, to maintain a patient in a “floating” position;

FIG. 12 is a perspective view of an alternative embodiment of applicant's inflatable air mattress, such embodiment utilizing a single chamber and being shown in deflated condition;

FIG. 13 is a perspective view of the alternative embodiment of FIG. 12 in inflated condition;

FIGS. 14-16 show, in sequence, the manner in which the preferred embodiment of applicant's inflatable air mattress rotates a patient from his back, to his front or chest, and then onto the support surface of a transfer cart;

FIG. 17 is a perspective view of the alternative embodiment of FIG. 12, showing the cells within the chamber in inflated condition; and

FIG. 18 is a perspective view of the edges of two chambers of applicant's inflatable air mattress separated by a gap to accommodate bariatric patients.

### DETAILED DESCRIPTION

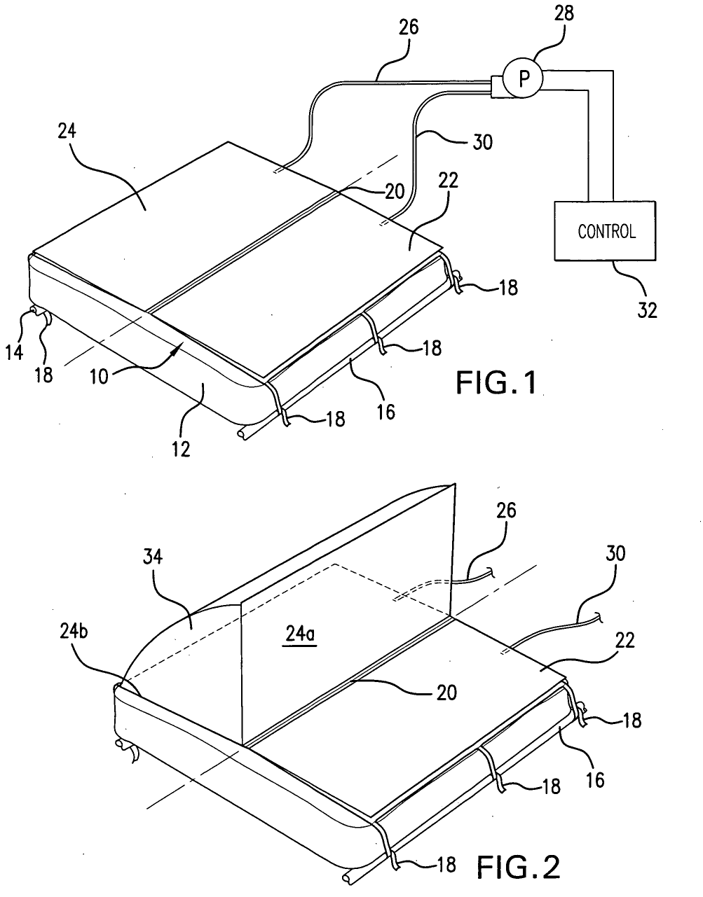

FIG. 1 shows air mattress 10, constructed in accordance with the principles of applicant's invention, positioned atop mattress 12 which rests upon rails 14, 16 of a conventional bed frame. Straps 18 depend from the opposite sides of mattress 10; the straps are secured to rails 14, 16 to retain inflatable air mattress 10 in fixed position on mattress 12. Hinge line 20 extends longitudinally along the center of air mattress 10, and divides mattress 10 into a pair of identical chambers 22, 24.

Conduit 26 extends from pump 28 to an entry port in chamber 22, while conduit 30 extends from pump 28 to an entry port in chamber 24. Control 32, which may assume the form of a keypad, or other manually operable device, controls the operation of pump 28. The pump may be energized to supply pressurized air to chambers 22 and/or 24, to either chamber.

FIG. 2 shows chamber 24 in its fully inflated condition. The upper surface 24a of the chamber has rotated through a 90° arc relative to lower surface 24b, for the lower surface is secured upon the bed by straps 18. Gusset 34, is normally retained in a triangular, inwardly extending fold extending between surfaces 24a and 24b, when the chamber 24 is in its deflated condition. However, when chamber 24 is pressurized by pump 28 over conduit 26, the gusset expands outwardly. The upper surface 24a of chamber 24 pivots about hinge line 20.

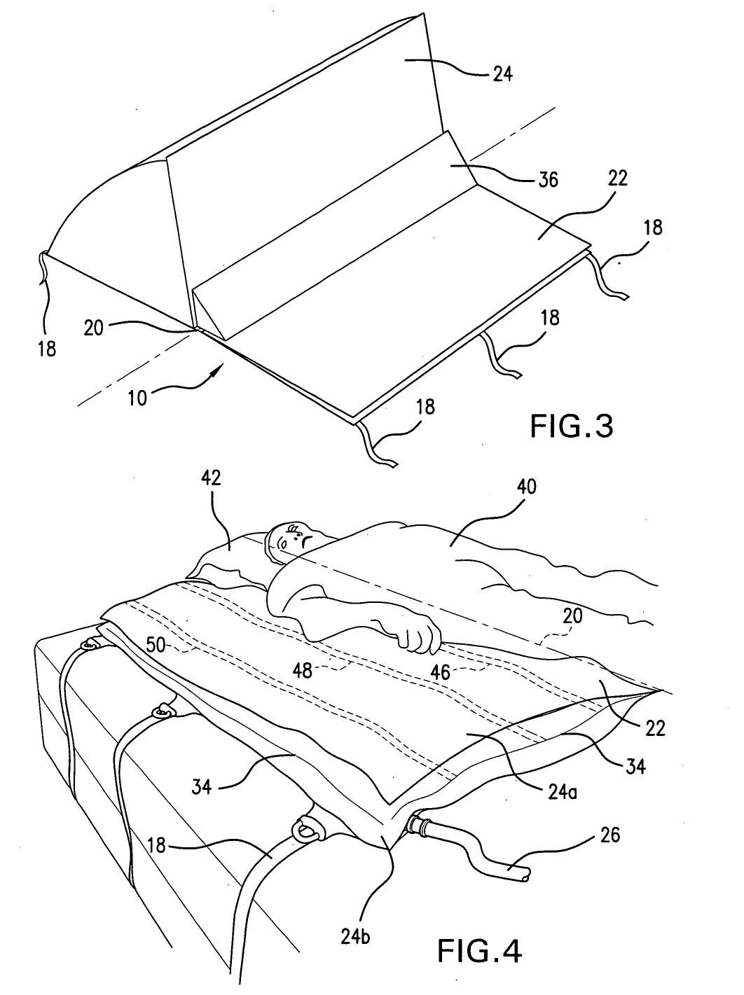

FIG. 3 reveals bolster 36, of triangular shape, that is positioned along hinge line 20. Bolster 36 is triangular in shape and assists in rotating a patient, positioned on air mattress 10, from his back to his front, or chest, and vice versa, as the air mattress is inflated.

FIG. 4 shows patient 40, resting on his back, with pillow 42 supporting his head. Patient 40 is resting on chamber 42, while chamber 24, and hinge line 20 are visible. Chamber 24 includes upper surface 24a, lower surface 24b, with an inwardly extending gusset 44 joining the upper and lower surfaces. Parallel cells extend longitudinally along the length of chamber 24; the cells are defined in the interior of chamber 24 between the upper and lower surfaces. Cells 46, 48, and 50 are shown in dotted outline. The cells are spaced a short distance laterally from the adjacent cell, and each cell may pivot slightly relative to its adjacent cell. Chamber 22 is identical in construction to chamber 24.

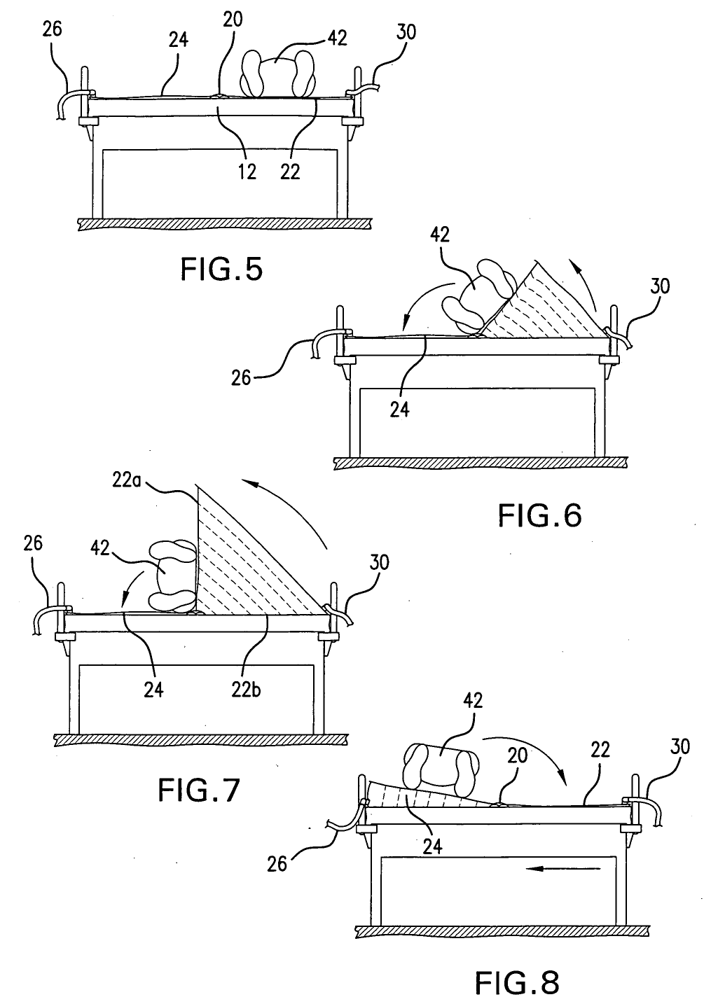

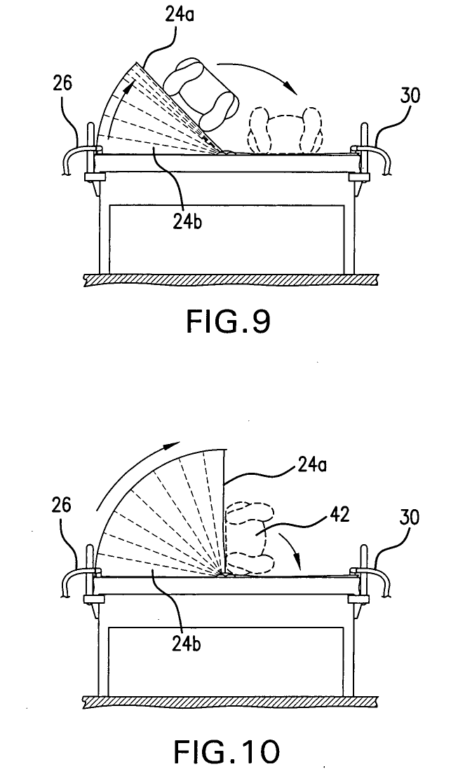

FIGS. 5-8 show the sequence of steps involved in rotating patient 42 from his back to his front, or chest. Chambers 22 and 24 are deflated, and patient 42 is resting upon chamber 22. Control 32 is operated by a nurse or care giver, to turn pump 28 “on”, and deliver pressurized air over conduit 30 to chamber 22. The cells in chamber 22 are shown in dotted outline. The cells expand, and the gusset between the upper and lower surfaces of the chamber is unfolded. The upper surface of the chamber pivots progressively about hinge line 20, as shown in FIGS. 6 and 7. The side of patient 42 contacts hinge line 20, and the patient is rotated onto his back, with an assist from the nurse or care giver. After performing the requisite nursing protocol on the exposed back side of the patient, the procedure for rotating patient 42 is reversed, as shown in FIGS. 8-10.

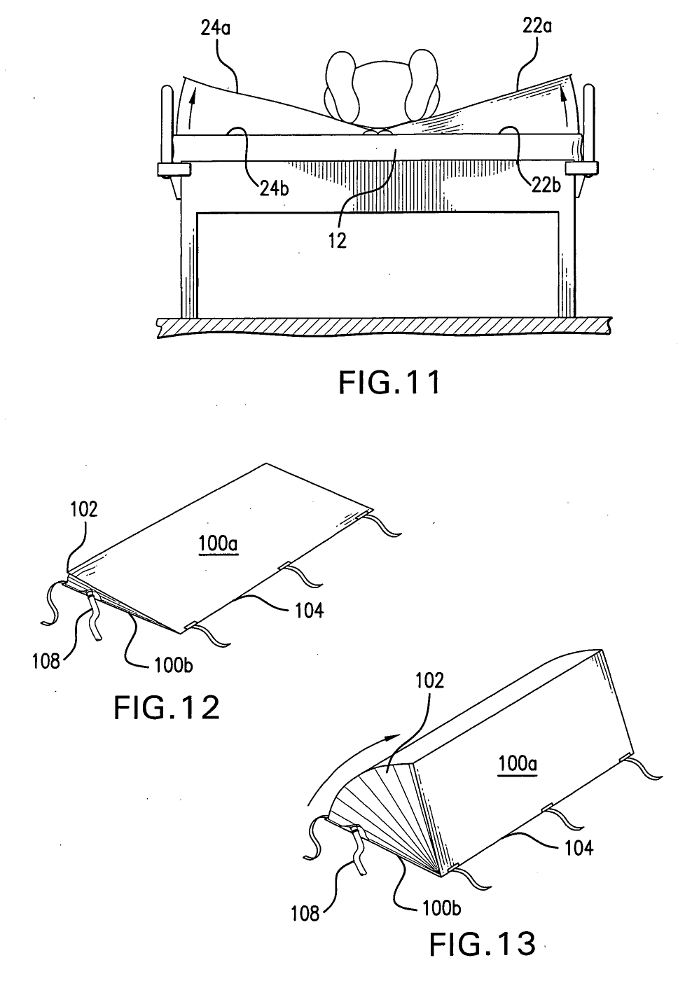

FIG. 11 shows patient 42 in an equilibrium, or “floating” position, supported by partially inflated chambers 24 and 22. The angular relationship of upper surface 24a of chamber 24 to the horizontal plane of mattress 12 is equal to the relationship of upper surface 22a of chamber 22 to the horizontal plane of mattress 12. The patient rests above hinge line 20 that separates the chambers.

FIGS. 12 and 13 depict a first alternative embodiment of applicant's inflatable air mattress, identified generally by reference numeral 100. Inflatable air mattress 100 includes an upper surface 100a, a lower surface 100b, and a gusset 102 that extends around three sides of mattress 100. The upper and lower surfaces are joined together along hinge line 104, so that the surface can pivot relative to the lower surface, which is remained in fixed positron by straps 106. The straps secure mattress 100 to a support, such as a bed frame or a conventional mattress. Mattress 100 assumes the form of a single chamber, in contrast to the pair of chambers utilized in the preferred embodiment.

Conduit 108 delivers pressurized air from a pump (not shown) in response to operation of a control. Several cells are defined in the interior of mattress 100, and as the cells are filled with air and expand, the upper surface 100a pivots almost 90° around hinge line 104, as suggested by the directional arrow in FIG. 13. A patient supported on surface 100a is rotated onto his side, and with assistance from a nurse or care giver, is rotated an additional 90° onto his previously unexposed side.

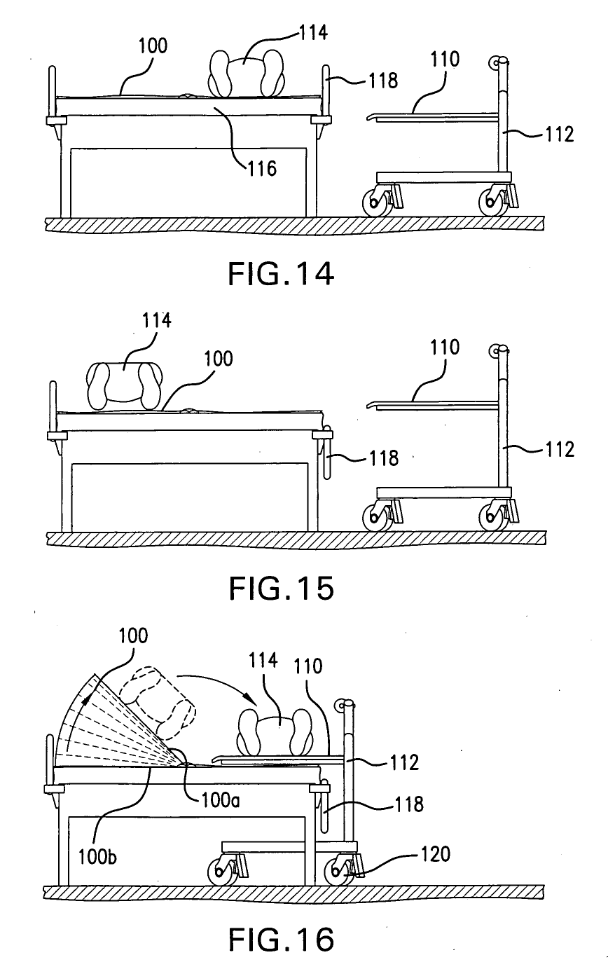

The manner in which inflatable air mattress is used to position a patient on the upper shelf 110 of transfer cart 112 is shown in FIGS. 14-16; the height of shelf 110 may be adjusted. Patient 114 is resting on his back on the right hand side of conventional mattress 116, and air mattress 100, in deflated condition, is resting on the left hand side of the bed, in FIG. 14. Patient 114 is rolled over onto his front, or chest, through the efforts of a nurse and/or care giver, to the position shown in FIG. 15. Transfer cart 112 is then pushed into engagement with the right side of conventional mattress 12, side rail 118 is lowered, and wheels 120 on cart 112 are locked in fixed position. Air mattress 100 is then inflated via conduit 108, so that the upper surface 100a pivots almost 60° about hinge line 104, and patient 114 is rotated 180° into a safe position on upper shelf 110 of cart 112.

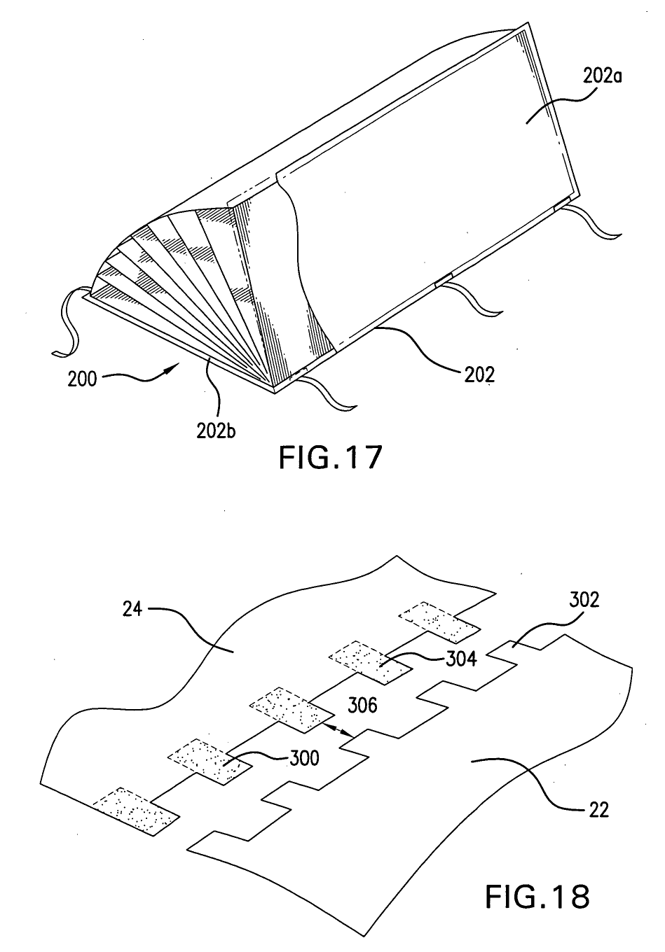

FIG. 17 shows a second alternative embodiment of applicant's inflatable air mattress, identified generally by reference numeral 200. The upper surface 200a responds to the introduction of pressurized air, via a conduit (now shown) by pivoting relative to lower surface 200b about hinge line 202. The single chamber of inflatable air mattress 200 may be divided into separate cells, as suggested in FIG. 17.

FIG. 18 shows a discontinuous hinge line defined between identical chambers 22, 24 in the preferred embodiment of FIGS. 1-10. Hine line 20 is replaced by interleaved tabs 300, 302, appearing on the adjacent edges of chambers 22,24. Hook and eye fasteners 304 are defined on the contacting surfaces of the tabs. The tabs provide gap 306 between the adjacent chambers; the gap is sufficiently large to accommodate bariatric patients who could not be rotated, or even turned, by known patient turning devices, even when skilled nurses or care givers are involved.

Other refinements, and improvements, will occur to the skilled artisan from a consideration of the specification and drawings. Consequently, the appended claims should be broadly construed in a manner consistent with the spirit, and scope, of applicant's unique inflatable air mattress.

What is claimed is:

1. An inflatable air mattress for rotating patients to administer nursing protocols, said air mattress comprising:
a) a bottom layer and a top layer positioned, in deflated condition, upon a mattress on a bed frame;
b) means for securing said bottom layer of said air mattress to the bed frame;
c) said top layer containing several parallel cells;
d) a hinge line joining said top layer to said bottom layer along one common edge,
e) means connected to said lower layer for introducing pressurized air into said bottom and top layers of said air mattress;
f) said pressurized air inflating said cells in said top layer causing said top layer to pivot about said hinge line, whereby a patient placed upon said air mattress will be rotated through an angle approaching 90°.

2. An inflatable air mattress as defined in claim 1, wherein said cells in said upper layer extend longitudinally along the length of said top layer.

3. An inflatable air mattress as defined in claim 2, wherein said cells in said upper layer extend parallel to said hinge line.

4. An inflatable air mattress as defined in claim 1, wherein a gusset extends between said top layer and said bottom layer of said air mattress.

5. An inflatable air mattress as defined in claim 4, wherein said gusset is integrally formed with said top and bottom layers of said air mattress.

6. An inflatable air mattress as defined in claim 4, wherein said gusset is folded inwardly between said top and bottom layers, when said air mattress is in deflated condition.

7. An inflatable air mattress as defined in claim 5, wherein said gusset is deployed, when said air mattress is inflated, to control the spacing between said top layer and said bottom layer.

8. An inflatable air mattress as defined in claim 1, wherein said means for securing said bottom layer to the bed frame comprises a plurality of straps.

9. An inflatable air mattress as defined in claim 1 formed of a leak-proof, rubberized material, that can be wiped clean.

10. A method of utilizing an inflatable air mattress to rotate a patient from his back to his front or chest, or vice versa, said inflatable air mattress comprising a bottom layer and a top layer, a plurality of cells defined in said top layer, a hinge line joining said top and bottom layers together along a common side, said method comprising the steps of:
a) securing the bottom layer to a bed frame or other support surface;
b) positioning a patient on said air mattress to one side of said hinge line;
c) introducing pressurized air into said bottom lawyer to inflate said cells in said upper layer;
d) the inflation of said cells causing said top layer to pivot about said hinge line and rotate the patient placed thereon to a position wherein nursing protocols may be practiced.

11. The method of claim 10, wherein said patient is rotated 90° from the horizontal plane of the air mattress to rest upon his side.
